(19) United States
(12) Patent Application Publication
(10) Pub. No.: US 2010/0263038 A1
(43) Pub. Date: Oct. 14, 2010

(54) Portable electronic device and personal authentication system with non-rewritable attribute memory

(76) Inventor: Yoshiki Nagatomo, Tokyo (JP)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 11/606,247

(22) Filed: Nov. 30, 2006

(30) Foreign Application Priority Data
Feb. 28, 2006 (JP) 2006-053148

(51) Int. Cl. G06F 7/04

(52) U.S. Cl. 726/9

(57) ABSTRACT

A portable electronic device has an attribute memory such as a one-time programmable read-only memory that non-rewritably stores an original attribute characterizing an authenticatee. When the authenticatee uses the portable electronic device at an authentication terminal, the authenticatee inputs the same attribute to the authentication terminal. The input attribute is sent from the authentication terminal to the portable electronic device and compared with the original attribute in the portable electronic device. Alternatively, the original attribute is sent from the portable electronic device to the authentication terminal and compared with the input attribute in the authentication terminal. The use of a non-rewritable attribute memory improves the security of the authentication system.

### BACKGROUND OF THE INVENTION

1. Field of the Invention

The present invention relates to personal authentication technology, more particular to a portable electronic device used in personal authentication, a personal authentication system, a personal authentication method, and a method of manufacturing a semiconductor device included in the portable electronic device.

2. Description of the Related Art

A high level of security is required to prevent the unauthorized use of cards at, for example, banks' automated teller machines (ATMs). In most ATM systems at present, personal authentication is carried out by using a four-digit personal identification number (PIN). These systems match a PIN entered at the ATM by the card user or authenticatee against a PIN prerecorded in the ATM system. However, as is evident from the frequent occurrence of card counterfeiting and other such incidents, this method does not always succeed in maintaining adequate security.

In recent years, biometric personal authentication systems making use of personal features such as fingerprint patterns, iris patterns, or vein patterns have been tried out on an experimental basis. The authenticatee's pattern is preregistered in the ATM system, and matched against a pattern obtained directly from the authenticatee at the ATM. Biometric authentication systems have shown a higher level of security than PINs, but they are still not entirely secure, one reason being that the preregistered patterns are generally stored in a rewritable medium in the system. The system is accordingly vulnerable to a type of attack in which the attacker penetrates the bank's computer system and replaces, say, a preregistered fingerprint pattern with an accomplice's fingerprint pattern, enabling the accomplice to make unauthorized use of a stolen or counterfeited card.

A proposed method of preventing such attacks is to store the preregistered pattern in the card itself. Japanese Patent Application Publication No. 10-312459, for example, proposes a portable electronic device such as a smart card having an electrically erasable programmable read-only memory (EEPROM) in which preregistered biometric information is stored, and a central processing unit that compares the preregistered biometric information with biometric information entered through external equipment. EEPROM, however, is a type of rewritable memory, so the stored biometric information is vulnerable to tampering, even if the card has anti-tampering features, and the risk of unauthorized use of the portable electronic device remains.

### SUMMARY OF THE INVENTION

An object of the present invention is to reduce the risk of unauthorized use of a portable electronic device.

The present invention provides a portable electronic device capable of bi-directional communication with an authentication terminal. The portable electronic device comprises an attribute memory that non-rewritably stores an original attribute characterizing an authenticatee. The attribute memory may be a ferroelectric one-time programmable read-only memory.

The stored original attribute can be matched against an input attribute obtained by the authentication terminal from a person attempting to use the portable electronic device, to authenticate the person's identity before such use is permitted. This may be done by transmitting the input attribute from the authentication terminal to the portable electronic device, performing a matching operation in the portable electronic device, and transmitting the result to the authentication terminal. Alternatively, the original attribute may be transmitted from the portable electronic device to the authentication terminal and the matching operation may be performed in the authentication terminal.

Since the original attribute is stored in a non-rewritable memory, the stored attribute is substantially tamper-proof. The risk of unauthorized use of the portable electronic device is reduced accordingly.

The present invention also provides a personal authentication method in which an authentication terminal communicates bi-directionally with a portable electronic device having a non-rewritable memory, a non-volatile random access memory, and a computing device. The method comprises:

storing an original attribute in the non-rewritable memory in the portable electronic device;

entering an input attribute obtained from an authenticatee at the authentication terminal;

transmitting the input attribute from the authentication terminal to the portable electronic device;

matching the received input attribute against the stored original attribute by using the computing device in the portable electronic device;

transmitting the matching result to the authentication terminal; and

storing the input attribute in the non-volatile random access memory in the portable electronic device if the matching result indicates that the original attribute does not match the input attribute.

Storing non-matching input attributes in a non-volatile random access memory in the portable electronic device further deters unauthorized use of the portable electronic device by making it possible to identify the unauthorized would-be user.

The present invention also provides a method of fabricating a semiconductor device for use in the above portable electronic device. The method comprises:

forming transistors on a first major surface of a substrate;

forming lower electrodes electrically connected to the transistors;

forming a ferroelectric film on the substrate, covering the lower electrodes;

forming a metal film on the ferroelectric film;

patterning the ferroelectric film and the metal film in a first area so as to leave a remaining part of the ferroelectric film and the metal film on the lower electrodes in the first area, the remaining part having an area equal to or less than an area of the lower electrodes, thereby forming a non-volatile random access memory; and

simultaneously patterning the ferroelectric film and the metal film in a second area so as to leave a remaining part of the ferroelectric film and the metal film on the lower electrodes in the second area, the remaining part having an area greater than an area of the lower electrodes, thereby forming a one-time programmable read-only memory.

This method enables a semiconductor device including both non-volatile random access memory and one-time programmable read-only memory to be manufactured efficiently and at a comparatively low cost.

In the present specification, ‘attribute characterizing an authenticatee’ means information describing an attribute possessed uniquely by the authenticatee and not possessable by any other person. ‘Non-rewritably’ means that the stored attribute information cannot be erased or altered. A one-time programmable read-only memory is a memory in which information can be written but cannot be erased or rewritten. A ‘non-volatile random access memory’ is a memory in which information is readable, writable, erasable, and rewritable at arbitrary addresses, and which stores written information indefinitely even when not supplied with power.

### BRIEF DESCRIPTION OF THE DRAWINGS

In the attached drawings:

FIG. 1 is a block diagram illustrating a personal authentication system according to a first embodiment of the invention;

FIG. 2 is a schematic diagram showing an exemplary arrangement in an integrated circuit chip of the components of the portable electronic device in the first embodiment;

FIG. 3A is a schematic sectional diagram showing the structure of a memory cell in the one-time programmable memory (OTP-ROM) in FIGS. 1 and 2;

FIG. 3B is a circuit diagram of the OTP-ROM memory cell;

FIG. 4A is a schematic sectional diagram showing the structure of a memory cell in the non-volatile random access memory (RAM) in FIGS. 1 and 2;

FIG. 4B is a circuit diagram of the non-volatile RAM memory cell;

FIGS. 5A and 5B constitute a flowchart illustrating the personal authentication procedure in the first embodiment;

FIG. 6 is a schematic diagram illustrating data exchanges between the authentication terminal and the portable electronic device in the first embodiment;

FIG. 7 is a block diagram illustrating a personal authentication system according to a second embodiment of the invention;

FIGS. 8A and 8B constitute a flowchart illustrating the personal authentication procedure in the second embodiment;

FIG. 9 is a schematic diagram illustrating data exchanges between the authentication terminal and the portable electronic device in the second embodiment; and

FIGS. 10 to 17 are schematic sectional views illustrating successive stages in the manufacture of a semiconductor device.

### DETAILED DESCRIPTION OF THE INVENTION

Embodiments of the invention will now be described with reference to the attached drawings, in which like elements are indicated by like reference characters.

### First Embodiment

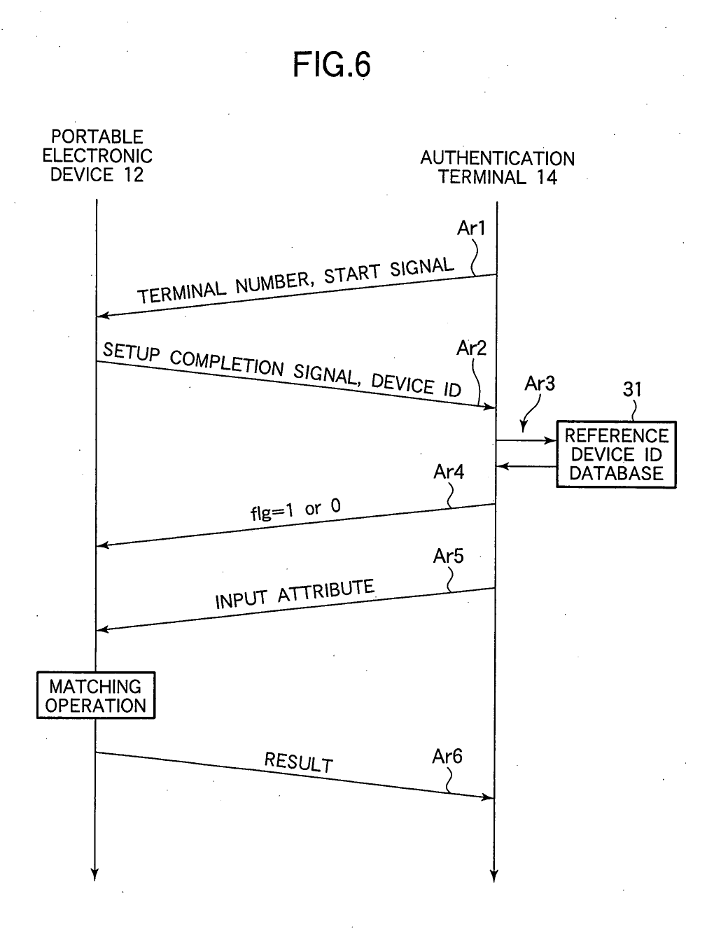

A first embodiment of the invented personal authentication system will be described with reference to the drawings up to FIG. 6. The description will also encompass a portable electronic device and a personal authentication method.

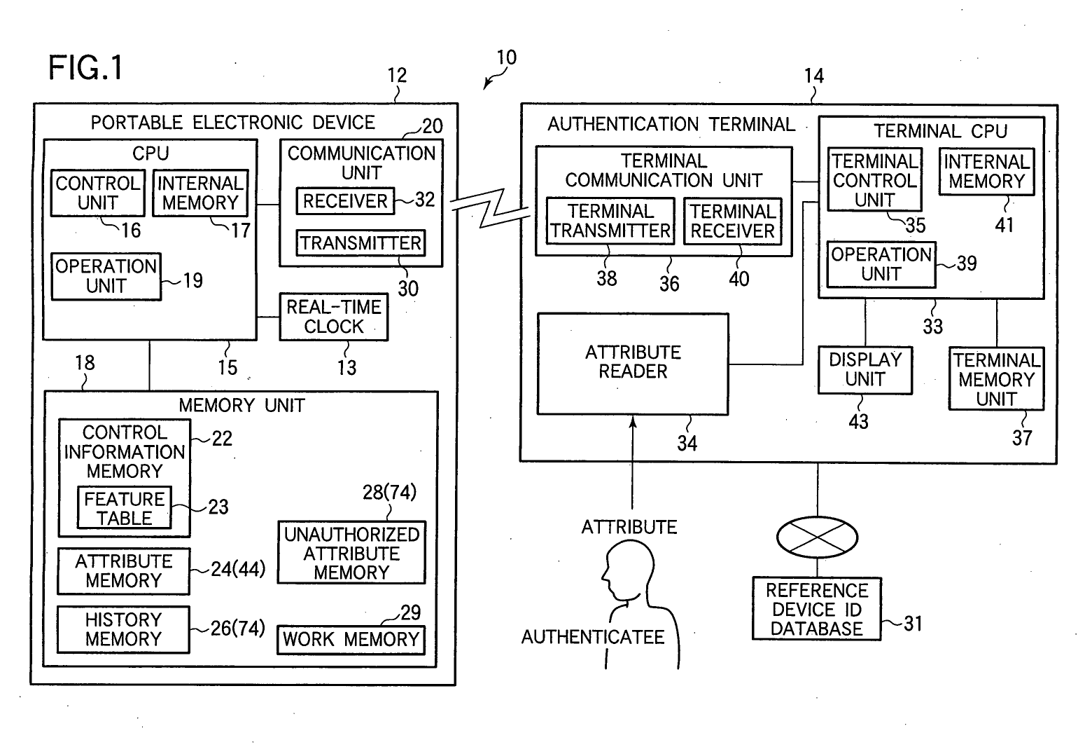

Referring to FIG. 1, the personal authentication system 10 comprises a portable electronic device 12 and an authentication terminal 14.

The portable electronic device 12 comprises a real-time clock 13, a central processing unit (CPU) 15, a memory unit 18, and a communication unit 20.

The CPU 15 comprises a control unit 16, an internal memory 17, and an operation unit 19. The CPU 15 is connected to the real-time clock 13, memory unit 18, and communication unit 20 by a data bus.

The control unit 16 controls the overall operation of the portable electronic device 12 during personal authentication according to one or more application programs, as described below.

The internal memory 17 temporarily stores information that arises during operation of the CPU 15.

The operation unit 19 performs various functions when the CPU 15 executes application programs etc. One of these functions is a matching function, which will be described later.

The memory unit 18 is external to the CPU 15. The memory unit 18 includes a control information memory 22, an attribute memory 24, a history memory 26, an unauthorized attribute memory 28, and a work memory 29. Except for the attribute memory 24, these memories are optional.

By executing the application programs, the CPU 15 executes personal authentication in cooperation with the authentication terminal 14.

The control information memory 22 is a read-only memory (ROM). The control information memory 22 stores the application programs that run on the CPU 15. The application programs control the functions of the operation unit 19 in the portable electronic device 12 during authentication, as will be described below. The control information memory 22 stores a feature table 23 that the control unit 16 refers to during matching. The feature table 23 stores a plurality of features characterizing the attribute. If, for example, a fingerprint pattern is used as an attribute, the feature table 23 stores features such as bifurcations, endings, deltas, divergences, and dots of fingerprint ridges. During matching, the control unit 16 compares two attributes (an input attribute and an original attribute) feature by feature.

The attribute memory 24 comprises a non-rewritable one-time programmable read-only memory (OTP-ROM) 44. The attribute memory 24 stores an attribute, such as a fingerprint pattern, characterizing an authenticatee. The attribute stored in the attribute memory 24 is referred to below as the original attribute. The attribute memory 24 also stores a unique identifier (referred to below as a device ID) characterizing the portable electronic device 12. The OTP-ROM 44 that constitutes the attribute memory 24 will be described below.

The history memory 26 comprises a non-volatile random access memory (RAM) 74. The history memory 26 stores a history of personal authentication that has been carried out.

The unauthorized attribute memory 28 comprises a non-volatile random access memory 74. If fraudulent personal authentication is attempted, the unauthorized attribute memory 28 stores the attribute, e.g., the fingerprint pattern, of the fraudulent user. The non-volatile RAM 74 constituting the history memory 26 and the unauthorized attribute memory 28 will be described below.

The work memory 29 comprises a volatile type of RAM such as static random access memory (SRAM). The work memory 29 temporarily stores an input attribute input by an authenticatee to the authentication terminal 14 and transmitted to the portable electronic device 12 for matching.

The communication unit 20 comprises a transmitter 30 and a receiver 32.

The transmitter 30 transmits personal authentication matching results and various other information from the portable electronic device 12 to the authentication terminal 14 under control of the control unit 16.

The receiver 32 receives input attributes of authenticates and various other information from the authentication terminal 14 under control of the control unit 16.

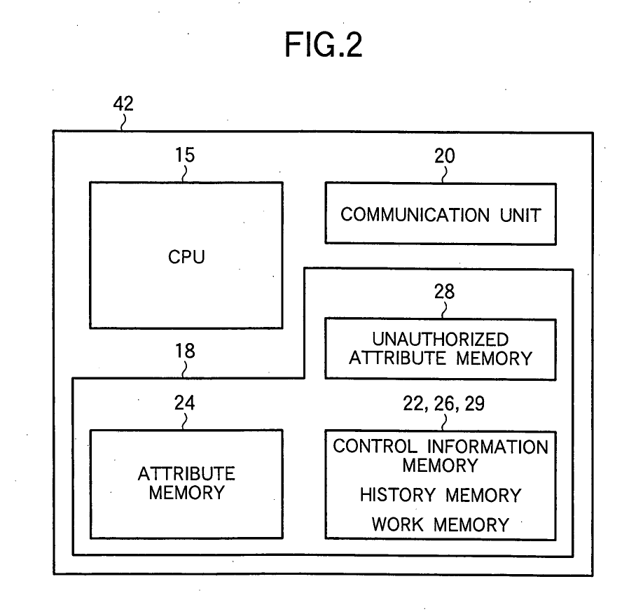

The portable electronic device 12 is preferably a smart card or equivalent device. The CPU 15, memory unit 18, and communication unit 20 are integrated into an integrated circuit (IC) chip embedded in the smart card. The CPU 15, memory unit 18, and communication unit 20 are laid out in the IC chip 42 as shown, for example, in FIG. 2.

Referring to FIG. 1 again, the authentication terminal 14 comprises a terminal CPU 33, an attribute reader 34, a terminal communication unit 36, a terminal memory unit 37, and a display unit 43. The authentication terminal 14 also comprises a host communication unit (not shown) for exchanging information between the authentication terminal 14 and a host computer. The host computer stores reference device IDs in a reference device ID database (referred to below simply as a database) 31.

The terminal CPU 33 comprises a terminal control unit 35, an operation unit 39, and an internal memory 41.

The terminal control unit 35 controls the overall operation of the authentication terminal 14 according to application programs stored in the terminal memory unit 37.

The internal memory 41 temporarily stores information that arises during operation of the terminal CPU 33.

The operation unit 39 performs various functions when the terminal CPU 33 executes application programs etc. These functions include, for example, matching, flag generation, and flag decision, as well as other functions.

By executing the application programs, the terminal CPU 33 executes personal authentication in cooperation with the portable electronic device 12.

The attribute reader 34 comprises, for example, an image input means such as an optical imaging means, and other input means. The attribute reader 34 acquires the attribute of an authenticatee during personal authentication. The attribute acquired by the attribute reader 34 from the authenticatee is referred to below as the input attribute.

The terminal communication unit 36 comprises a terminal transmitter 38 and a terminal receiver 40.

The terminal transmitter 38 transmits input attribute information and various other information to the receiver 32 in the portable electronic device 12 under control of the terminal control unit 35.

The terminal receiver 40, also operating under control of the terminal control unit 35, receives personal authentication matching results and various other information transmitted from the transmitter 30 in the portable electronic device 12. The terminal receiver 40 stores the received information in the internal memory 41.

The display unit 43 displays various messages to the authenticatee under control of the terminal control unit 35.

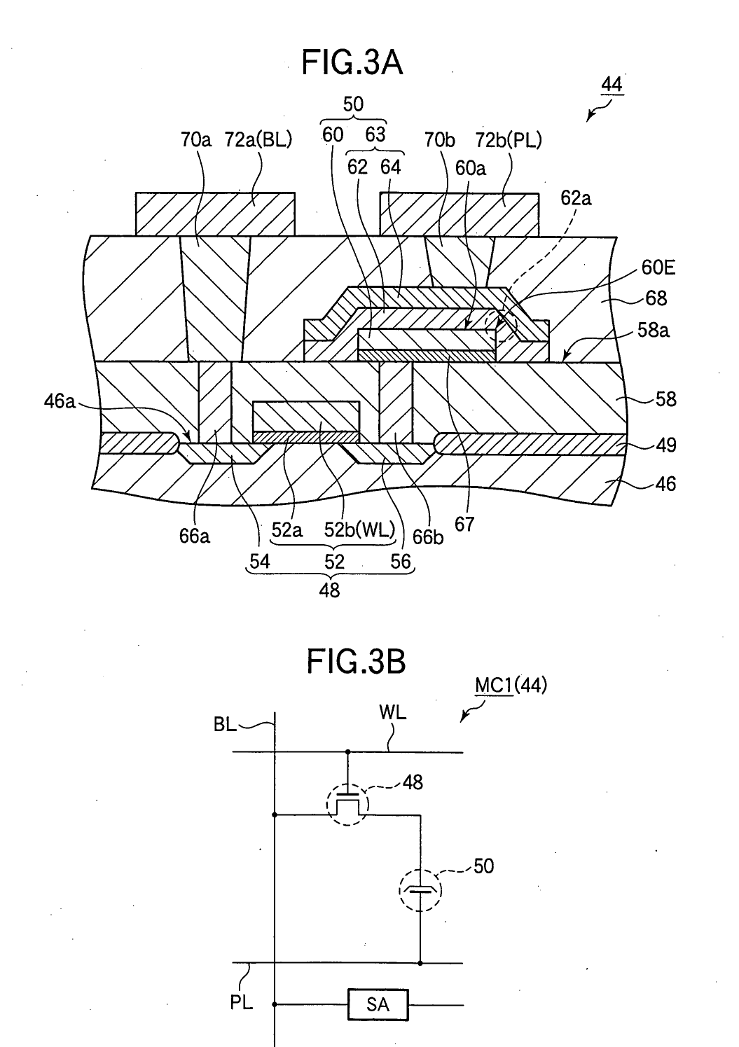

Next, the structure and operation of the OTP-ROM 44 constituting the attribute memory 24 will be described with reference to FIGS. 3A and 3B.

FIG. 3A is a schematic sectional diagram of the structure of a memory cell in the OTP-ROM 44. The OTP-ROM 44 is disposed on a first major surface 46a of a substrate 46. The main constituent elements of the memory cell are a transistor 48 and a capacitor 50. One preferred type of substrate 46 is a silicon substrate.

The transistor 48 comprises a gate 52, a drain 54, and a source 56.

The gate 52 has a structure in which a gate electrode 52b is disposed on a gate oxide film 52a on the first major surface 46a. The gate electrode 52b is part of a word line WL that also functions as the gate electrodes of other transistors 48 (not shown). Examples of preferred materials are silicon oxide for the gate oxide film 52a and polysilicon for the gate electrode 52b.

The drain 54 and source 56 are areas in which impurities of a predetermined conductive type are diffused into the substrate 46 near its first major surface 46a. The gate 52 is disposed on the first major surface 46a between the drain 54 and the source 56.

Mutually adjacent transistors 48 are electrically isolated from one another by field oxide layers 49 formed on the first major surface 46a.

A lower dielectric film 58 is formed on the entire surface of the first major surface 46a, covering the transistor 48 and the field oxide layer 49. A pair of contact plugs 66a and 66b extend through the lower dielectric film 58. Contact plug 66a electrically connects the drain 54 of the transistor 48 to another contact plug 70a, which will be described below; contact plug 66b electrically connects the source 56 of the transistor 48 to the lower electrode 60 of the capacitor 50, which will be described below.

The capacitor 50 comprises the lower electrode 60, a capacitor dielectric film 62, and an upper electrode 64. The capacitor 50 is formed on the lower dielectric film 58.

The lower electrode 60 is formed on an adhesion layer 67 on the lower dielectric film 58. Examples of preferred materials are platinum for the lower electrode 60 and tantalum oxide for the adhesion layer 67.

The capacitor dielectric film 62 occupies an area including the area occupied by the lower electrode 60 but larger than the lower electrode 60. More specifically, the capacitor dielectric film 62 is patterned so that its areal extent exceeds the areal extent of the lower electrode 60. As a result, the capacitor dielectric film 62 extends onto the upper surface 58a of the lower dielectric film 58 surrounding the lower electrode 60 as well as covering the upper surface 60a of the lower electrode 60. Accordingly, the film thickness of the capacitor dielectric film 62 where it bends over the edges 60E of the upper surface of the lower electrode 60 is less than the film thickness of the flat parts of the capacitor dielectric film 62, such as the flat part near the center of the upper surface 60a. The parts of the capacitor dielectric film 62 disposed at the upper edges 60E of the lower electrode 60 will be referred to below as thin regions 62a. Because of the thin regions 62a, the dielectric breakdown voltage of the capacitor dielectric film 62 is lower than the dielectric breakdown voltage in the nonvolatile RAM 74, which will be described below. An example of a preferred material for the capacitor dielectric film 62 is ferroelectric strontium bismuth tantalate (SBT).

The upper electrode 64 is disposed on the capacitor dielectric film 62. The capacitor dielectric film 62 and the upper electrode 64 have congruent planar shapes. An example of a preferred material for the upper electrode 64 is platinum. The structure formed by the capacitor dielectric film 62 and upper electrode 64 may be referred to as a multilayer structure 63.

An upper dielectric film 68 is formed on the entire upper surface 58a of the lower dielectric film 58, covering the capacitor 50. A pair of contact plugs 70a and 70b are formed through the upper dielectric film 68. Contact plug 70a electrically connects the contact plug 66a described above to a wire 72a disposed on the upper dielectric film 68; contact plug 70b electrically connects the upper electrode 64 of the capacitor 50 to another wire 72b disposed on the upper dielectric film 68. Wire 72a functions as a bit line BL; wire 72b functions as a plate line PL.

Next, referring to FIG. 3B, the operation of the OTP-ROM 44 will be described. FIG. 3B shows a circuit diagram of a memory cell MC1 in the OTP-ROM 44. The symbol SA indicates a sense amplifier.

Referring to FIG. 3B, when ‘1’ data, for example, are written in the memory cell MC1, a voltage is applied to the word line WL. In this state, a voltage with a polarity corresponding to the ‘1’ data is applied between the bit line BL and the plate line PL, building up charge in the lower electrode 60 and upper electrode 64. The resulting electric field polarizes the crystal structure of the capacitor dielectric film 62, thereby writing ‘1’ data into the memory cell MC1. Because of the comparatively low dielectric breakdown voltage of the thin regions 62a of the capacitor dielectric film 62, however, in a short time electrostatic breakdown occurs in those regions 62a. The upper electrode 64 and lower electrode 60 are then electrically interconnected and can no longer store charge. The electric field substantially disappears, but the structural polarity of the capacitor dielectric film 62 remains unchanged.

When data are read from OTP-ROM 44, a voltage is applied to the word line WL and the plate line PL, and the voltage output on the bit line BL is sensed. If ‘1’ data are stored in the memory cell MC1, the voltage output on the bit line BL is comparatively high; if ‘0’ data are stored in the memory cell MC1, the voltage output on the bit line BL is comparatively low. The data are read out through the sense amplifier SA, which amplifies the high-low voltage difference.

As is clear from the description above, data can be written in the memory cell MC1 only once, because the writing process short-circuits its capacitor 50, making it impossible to create an electric field strong enough to change the polarity of the capacitor dielectric film 62. Accordingly, once data are written in memory cell MC1, the data cannot be erased or modified. This makes the OTP-ROM 44 a non-rewritable memory.

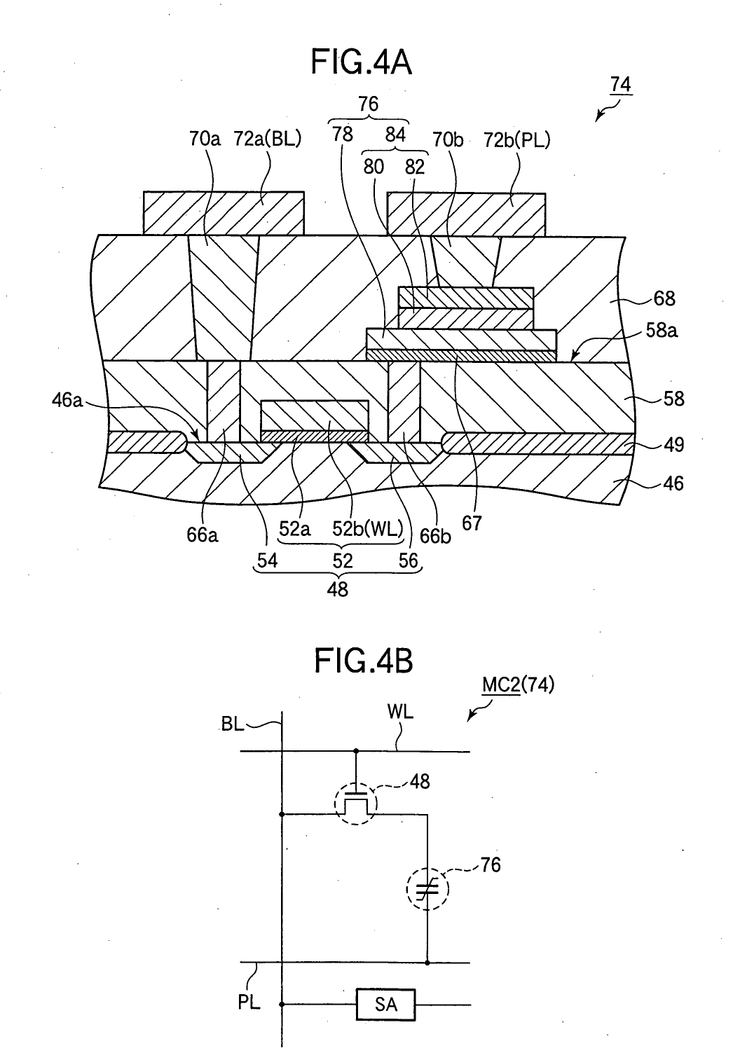

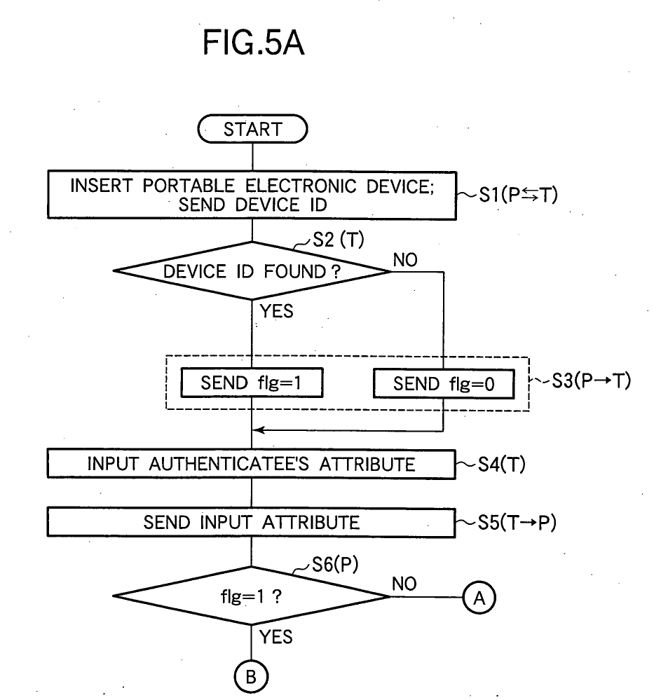

Next, the structure and operation of the nonvolatile RAM 74 constituting the history memory 26 and unauthorized attribute memory 28 will be described with reference to FIGS. 4A and 4B.

FIG. 4A is a schematic sectional diagram of the structure of a memory cell in the nonvolatile RAM 74. The same materials are used for the nonvolatile RAM 74 as for the nonvolatile RAM 74. The nonvolatile RAM 74 differs from the OTP-ROM 44 by including a different capacitor 76. The following description will concentrate on the differences between the OTP-ROM 44 and the nonvolatile RAM 74.

The capacitor 76 comprises a lower electrode 78, a capacitor dielectric film 80, and an upper electrode 82.

The planar shapes of the capacitor dielectric film 80 and the upper electrode 82 in the nonvolatile RAM 74 differ from the planar shapes of the capacitor dielectric film 62 and the upper electrode 64 in the OTP-ROM 44. Specifically, the capacitor dielectric film 80 in the nonvolatile RAM 74 is patterned as an island having an areal extent less than the areal extent of the lower electrode 78 on which it is disposed. Accordingly, the thin regions 62a that were formed in the OTP-ROM 44 are not formed in the nonvolatile RAM 74. As a result, the dielectric breakdown voltage of the capacitor dielectric film 80 is higher than the dielectric breakdown voltage of the capacitor dielectric film 62.

The upper electrode 82 and the capacitor dielectric film 80 have congruent planar shapes. The structure formed by the capacitor dielectric film 80 and the upper electrode 82 may be referred to as a multilayer structure 84.

Next, referring to FIG. 4B, the operation of nonvolatile RAM 74 will be described. FIG. 4B shows a circuit diagram of a memory cell MC2 in the nonvolatile RAM 74. The symbol SA again indicates a sense amplifier.

Referring to FIG. 4B, when ‘1’ data, for example, are written in the memory cell MC2, a voltage is applied to the word line WL. In this state, a certain voltage with a polarity corresponding to the ‘1’ data is applied between the bit line BL and the plate line PL, building up charge in the lower electrode 78 and upper electrode 82. The resulting electric field polarizes the crystal structure of the SBT material constituting the capacitor dielectric film 80 in the same direction, thereby writing ‘1’ data into the memory cell MC2. Similarly, when ‘0’ data are written in the memory cell MC2, a voltage with a polarity corresponding to the ‘0’ data, opposite to the polarity corresponding to the ‘1’ data, is applied between the bit line BL and the plate line PL, building up charge of opposite polarity in the lower electrode 78 and upper electrode 82. The resulting electric field polarizes the crystal structure of the SBT material constituting the capacitor dielectric film 80 in the direction opposite to the direction corresponding to the ‘1’ data, thereby writing ‘0’ data into the memory cell MC2. The polarization states of the capacitor dielectric film 80 are retained even if no power is supplied. As a result, even after the nonvolatile RAM 74 is powered off, the memory contents remain stored in the memory cell MC2.

When data are read from the memory cell MC2, a voltage is applied to the word line WL. A positive voltage is applied to the plate line PL, and the voltage output on the bit line BL is sensed. If ‘1’ data are stored in the memory cell MC2, the polarity of the capacitor dielectric film 80 is reversed, placing a comparatively high voltage on the bit line BL; if ‘0’ data are stored in the memory cell MC2, the polarity of the capacitor dielectric film 80 is not reversed, placing a comparatively low voltage on the bit line BL. The data are read out through the sense amplifier SA, which amplifies the high-low voltage difference.

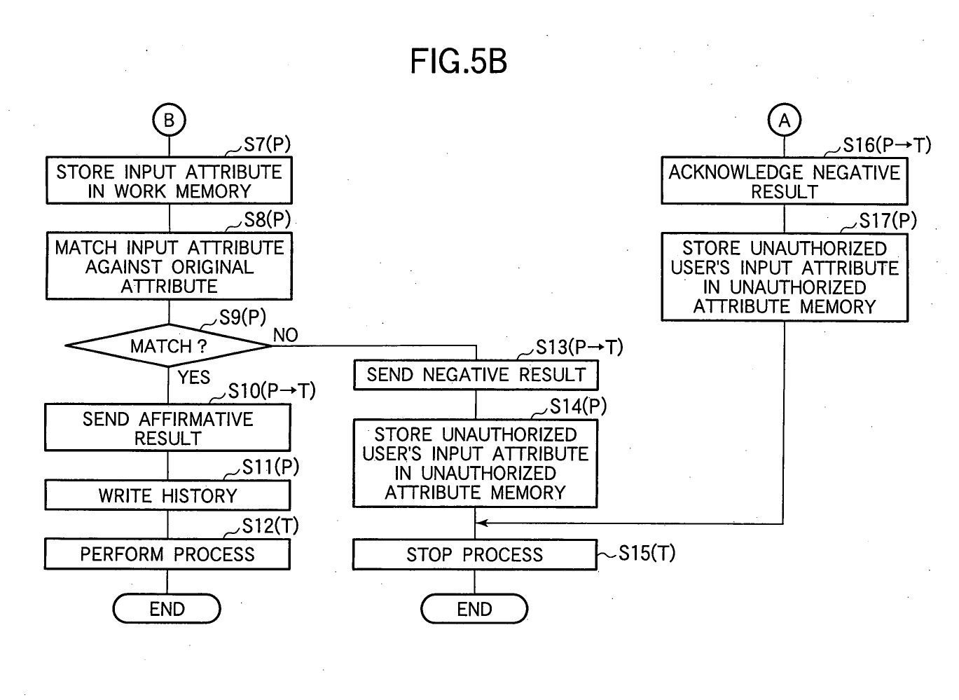

Next, the personal authentication process in the personal authentication system 10 will be described with reference to the flowchart in FIGS. 5A and 5B and the data exchange diagram in FIG. 6.

In FIGS. 5A and 5B, the letter P in parentheses after a step number indicates that the step is performed in the portable electronic device 12; the letter T in parentheses after a step number indicates that the step is performed in the authentication terminal 14. The notation P→T in parentheses after a step number indicates that the portable electronic device 12 transmits information to the authentication terminal 14 in the step; the notation T→P in parentheses after a step number indicates that the authentication terminal 14 transmits information to the portable electronic device 12.

In step S1 in FIG. 5A, the authenticatee sets the portable electronic device 12 in the authentication terminal 14. This allows the portable electronic device 12 to establish bi-directional communication with the authentication terminal 14, as indicated by the double arrows. The terminal control unit 35 in the authentication terminal 14 then sends a start signal and the terminal number of the authentication terminal 14 to the receiver 32 in the portable electronic device 12 via the terminal transmitter 38 (Ar1 in FIG. 6). When the control unit 16 in the portable electronic device 12 receives the start signal, it reads an authentication application program from the control information memory 22. This shifts the portable electronic device 12 into an authentication standby state. The control unit 16 temporarily stores the terminal number of the authentication terminal 14 in the internal memory 17.

Operating according to the application program, the control unit 16 reads the device ID from the attribute memory 24. When the device ID has been read, the transmitter 30 sends the device ID and a setup completion signal to the terminal receiver 40 in the authentication terminal 14 under control of the control unit 16 (Ar2 in FIG. 6).

In step S2, when the terminal receiver 40 receives the device ID and the setup completion signal, the device ID is temporarily stored in the internal memory 41 under control, of the terminal control unit 35. Responding to the reception of the device ID, the terminal control unit 35 in the authentication terminal 14 first executes the matching function to verify the device ID. More specifically, the terminal control unit 35 accesses the database 31 in the host computer via the network, and attempts to read a matching reference device ID. If a matching reference device ID is stored in the database 31, it is sent back to the authentication terminal 14; the terminal control unit 35 verifies that the reference device ID returned from the database 31 matches the device ID stored in the internal memory 41 (Ar3 in FIG. 6).

In step S3, when the device ID matches the reference device ID, the terminal control unit 35 concludes that the portable electronic device 12 is an authorized portable electronic device, and a flagging function in the terminal CPU 33 sets an ID matching flag (flg) to ‘1’. The terminal transmitter 38 sends this value (flg=1) to the receiver 32 in the portable electronic device 12 (Ar4 in FIG. 6).

If the result of device ID verification (in step S2) is that the device ID stored in the internal memory 41 does not match any reference device ID stored in the database 31, the terminal control unit 35 concludes that the portable electronic device 12 is unauthorized, and the flagging function in the terminal control unit 35 sets the ID matching flag to ‘0’. The terminal transmitter 38 sends this value (flg=0) to the receiver 32 in the portable electronic device 12 under control of the terminal control unit 35 (Ar4 in FIG. 6).

In step S4, regardless of whether the value of the ID matching flag is ‘1’ or ‘0’, the terminal control unit 35 accesses the terminal memory unit 37, and requests the authenticatee's attribute. More specifically, the terminal control unit 35 reads a message, requesting the authenticatee to enter the attribute, from the terminal memory unit 37, and causes the display unit 43 in the authentication terminal 14 to display this message. Following the message guidance, the authenticatee inputs his or her attribute, e.g., fingerprint pattern, to the authentication terminal 14 via the attribute reader 34.

In step S5, in the internal memory 41, the terminal control unit 35 temporarily stores the input attribute obtained by the attribute reader 34. The terminal transmitter 38 sends the stored input attribute to the receiver 32 in the portable electronic device 12 under control of the terminal control unit 35 (Ar5 in FIG. 6).

In step S6, the CPU 15 in the portable electronic device 12 tests the value of the ID matching flag sent from the authentication terminal 14 as described above. If the ID matching flag has a value of ‘1’ (flg=1, indicating authorized use) the CPU 15 proceeds to step S7 in FIG. 5B, which will be described later.

If the ID matching flag has a value of ‘0’ (flg=0, indicating unauthorized use) the CPU 15 proceeds to step S16 in FIG. 5B. In step S16, the control unit 16 sends a signal to the terminal receiver 40 in the authentication terminal 14 via the transmitter 30 acknowledging the negative result of device ID matching (Ar6 in FIG. 6).

In step S17, since the ID matching flag has the value ‘0’, the control unit 16 stores the input attribute of the unauthorized user in the unauthorized attribute memory 28. The CPU 15 then proceeds to step S15.

In step S7, since the ID matching flag has a value of ‘1’ (flg=1), the control unit 16 temporarily stores the input attribute received by the receiver 32 in the work memory 29.

In step S8, the operation unit 19 executes the attribute matching application program under control of the control unit 16. More specifically, the operation unit 19 performs the matching function that matches the input attribute stored in the work memory 29 against the original attribute stored in the attribute memory 24.

During matching, under control of the control unit 16, the operation unit 19 reads the feature table 23 of the original attribute stored in the control information memory 22. Referring to the feature table 23, the operation unit 19 matches the input attribute against the original attribute feature by feature.

In step S9, if the input attribute matches the original attribute, the CPU 15 proceeds to step S10; if the input attribute does not match the original attribute, the CPU 15 proceeds to step S13. In the first embodiment, the input attribute matches the original attribute if the number of features of the input attribute that match features of the original attribute is equal to or greater than a suitable threshold value, which may be set to any value that provides adequate security. If the number of features of the input attribute matching features of the original attribute is less than the threshold value, the input attribute does not match the original attribute. Accordingly, the operation unit 19 makes match/non-match decisions on the individual features of the input attribute, counts the number of matching features, and outputs a match or non-match signal according to the total matching count.

If the input attribute matches the original attribute (the matching result is affirmative), the CPU 15 receives a match signal, and the control unit 16 commands the CPU 15 to proceed to steps S10 to S12. If the input attribute does not match the original attribute (the matching result is negative), the CPU 15 receives a non-match signal, and the control unit 16 commands the CPU 15 to proceed to steps S13 to S15.

In step S10, having obtained an affirmative matching result, the transmitter 30 sends a signal indicating this result (a match signal) to the terminal receiver 40 in the authentication terminal 14 under control of the control unit 16 (Ar6 in FIG. 6).

In step S11, at the command of the control unit 16, the CPU 15 reads the date and time from the real-time clock 13, and the terminal number of the authentication terminal 14 from the internal memory 17. The CPU 15 writes the date, time, and terminal number in the history memory 26.

In step S12, when the terminal receiver 40 receives the affirmative matching result (match signal), the terminal control unit 35 controls the authentication terminal 14 to permit procedures that may be performed by an authenticated user to proceed. In an ATM system, for example, cash withdrawal is permitted. The personal authentication session ends when the procedure initiated by the authenticatee is completed.

In step S13, the portable electronic device 12 begins the process that is performed when the matching result is negative and the authenticatee is presumed to be a fraudulent user. First, under control of the control unit 16, the transmitter 30 sends the negative matching result (non-match signal) to the terminal receiver 40 in the authentication terminal 14 (Ar6 in FIG. 6).

Next, in step S14, under control of the control unit 16, the CPU 15 transfers the input attribute stored in the work memory 29 to the unauthorized attribute memory 28. Accordingly, the unauthorized attribute memory 28 stores the attribute of the fraudulent user.

In step S15, upon receiving the negative matching result (non-match signal), the terminal control unit 35 stops the procedure in progress in the authentication terminal 14. In an ATM system, for example, cash withdrawal is denied. The personal authentication process then ends.

Next, the effects of the personal authentication system 10, the portable electronic device 12, and the personal authentication method in the first embodiment will be described.

In the personal authentication system 10, the portable electronic device 12, and the personal authentication method described above, the attribute of the authenticatee is stored in the non-rewritable OTP-ROM 44 (attribute memory 24) in the portable electronic device 12. Therefore, tampering with the attribute stored in the portable electronic device 12 is completely prevented.

In the personal authentication system 10, the portable electronic device 12, and the personal authentication method described above, if fraudulent use is attempted, the input attribute of the fraudulent user is stored in the unauthorized attribute memory 28 (steps S14 and S17 in FIG. 5B). Accordingly, the attribute of the fraudulent user can be obtained from the portable electronic device 12 that has been fraudulently used. The attribute can then be used to identify the fraudulent user.

In the personal authentication system 10, the portable electronic device 12, and the personal authentication method described above, the device ID, the input attribute and the original attribute are used to determine whether unauthorized use of the portable electronic device 12 is being attempted. The risk of unauthorized use of the portable electronic device 12 can be further reduced by storing only the device IDs of portable electronic devices 12 that have been issued to authorized users in the database 31 of the host computer. Then even if a fraudulent user steals an unissued portable electronic device 12 not containing any attribute data, and writes the fraudulent user's own attribute into it, use of this unauthorized portable electronic device 12 can be prevented because its device ID will not match any reference device ID stored in the database 31.

In the personal authentication system 10, the portable electronic device 12, and the personal authentication method described above, matching is performed in the CPU 15 in the portable electronic device 12. The original attribute stored in the attribute memory 24 is not externally accessible, which increases the security of the attribute.

A biometric attribute characterizing the authenticatee may be used as an attribute. Examples include fingerprint patterns, voiceprint patterns, iris patterns, and palm vein patterns.

In the first embodiment, an OTP-ROM 44 of the destructive-write type is used as the attribute memory 24. A memory of the nondestructive-write type, however, may be used as the attribute memory 24, provided that data once written cannot be altered or erased.

### Second Embodiment

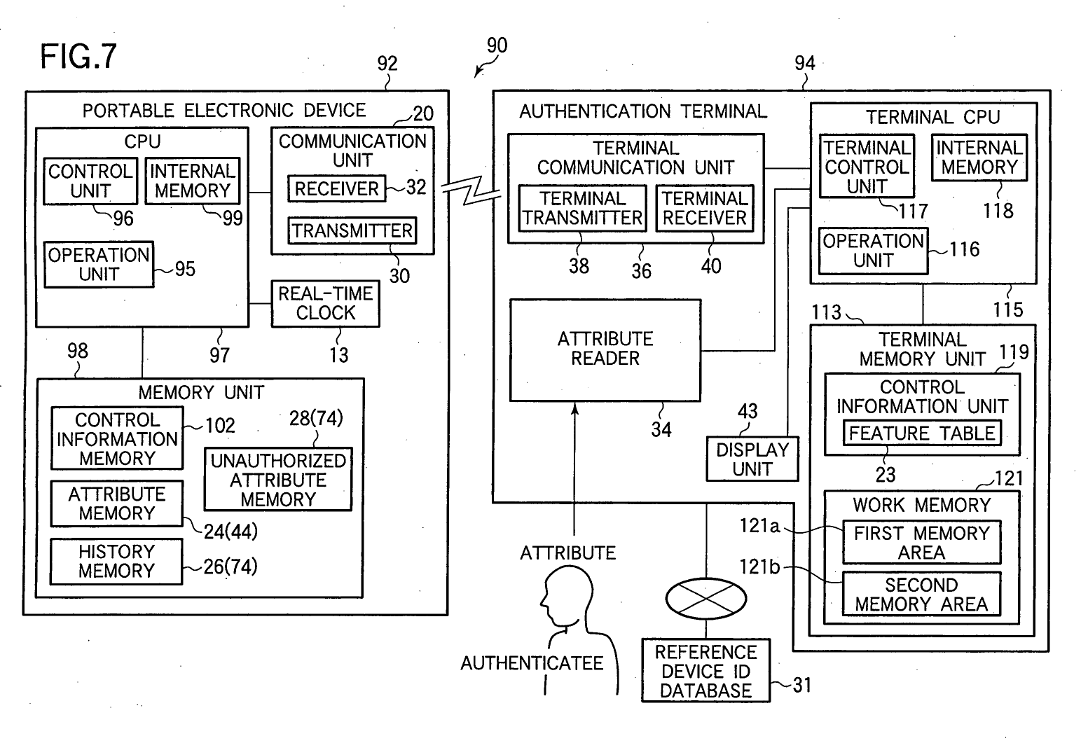

A second embodiment of the invented personal authentication system will be described with reference to FIGS. 7 to 9. The description will also encompass a portable electronic device and a personal authentication method. The personal authentication method in the second embodiment differs from the personal authentication method in the first embodiment by performing the matching operation in the authentication terminal.

Referring to FIG. 7, the personal authentication system 90 in the second embodiment comprises a portable electronic device 92 and the authentication terminal 94.

The portable electronic device 92 comprises a real-time clock 13, a communication unit 20, a CPU 97, and a memory unit 98.

The CPU 97 comprises an operation unit 95, a control unit 96, and an internal memory 99 similar to the operation unit 19, control unit 16, and internal memory 17 in the first embodiment. The CPU 97 is connected to the real-time clock 13, communication unit 20, and memory unit 98 by a data bus.

The control unit 96 controls the overall operation of the portable electronic device 92 during personal authentication according to application programs.

The internal memory 99 temporarily stores information that arises during operation of the CPU 97.

The operation unit 95 performs various functions when the CPU 97 executes application programs etc. One of these functions is a matching function, which will be described later.

By executing the application programs, the CPU 97 executes personal authentication in cooperation with the authentication terminal 94.

The memory areas in the memory unit 98 include an attribute memory 24, a history memory 26, an unauthorized attribute memory 28, and a control information memory 102.

The control information memory 102 stores the application programs that run on the CPU 97. The control information memory 102 differs from the control information memory 22 in the first embodiment in that it does not store a feature table.

The personal authentication system 90 executes personal authentication in the authentication terminal 94. Accordingly, the memory unit 98 does not include a work memory for personal authentication.

The communication unit 20, the attribute memory 24, the history memory 26, and the unauthorized attribute memory 28 are the same as in the portable electronic device 12 in the first embodiment.

The authentication terminal 94 comprises an attribute reader 34, a terminal communication unit 36, a display unit 43, a terminal memory unit 113, and a terminal CPU 115.

The terminal CPU 115 comprises an operation unit 116, a terminal control unit 117, and an internal memory 118 similar to the operation unit 39, terminal control unit 35, and internal memory 41 in the first embodiment.

The terminal control unit 117 controls the overall operation of the authentication terminal 94 according to application programs stored in the terminal memory unit 113.

The internal memory 118 temporarily stores information that arises during operation of the terminal CPU 115.

The operation unit 116 performs various functions when the terminal CPU 115 executes application programs etc. These functions include, for example, matching, flag generation, and flag decision as well as other functions.

By executing the application programs stored in the terminal memory unit 113, the terminal CPU 115 executes personal authentication in cooperation with the portable electronic device 92.

The terminal memory unit 113 comprises a control information memory 119 and a work memory 121.

The control information memory 119 is a ROM storing the application programs that run on the terminal CPU 115. The application programs control the functions of the operation unit 116 in the authentication terminal 94 during authentication, as described below. The control information memory 119 stores a feature table 23 that the terminal control unit 117 refers to during matching. The feature table 23 is the same as in the first embodiment.

The work memory 121 is a dynamic random access memory (DRAM) that includes a first memory area 121a and a second memory area 121b.

The first memory area 121a temporarily stores the original attribute received from the portable electronic device 92 during matching.

The second memory area 121b temporarily stores the input attribute input from the attribute reader 34 during matching.

The attribute reader 34, the terminal communication unit 36, and the display unit 43 are the same as in the authentication terminal 14 in the first embodiment. The authentication terminal 94 comprises the same host communication unit (not shown) as in the first embodiment, and exchanges information with a database 31 in a host computer.

Next, the personal authentication process in the personal authentication system 10 will be described with reference to the flowchart in FIGS. 5A and 5B and the data exchange diagram in FIG. 6.

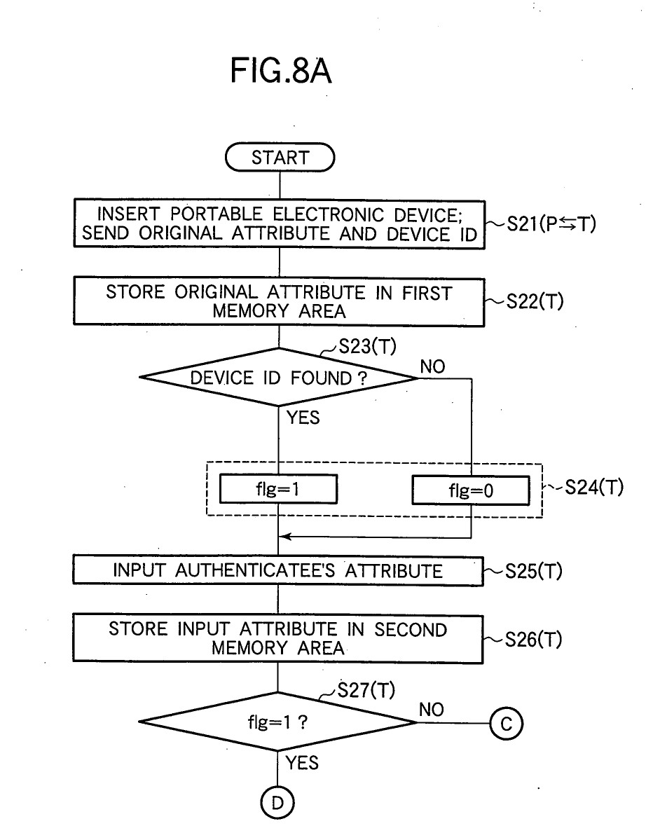

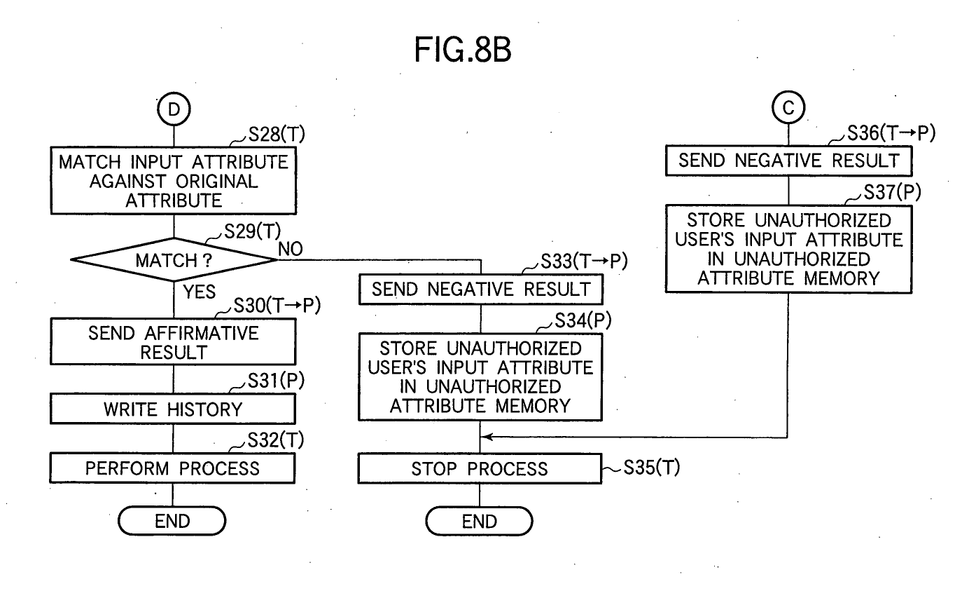

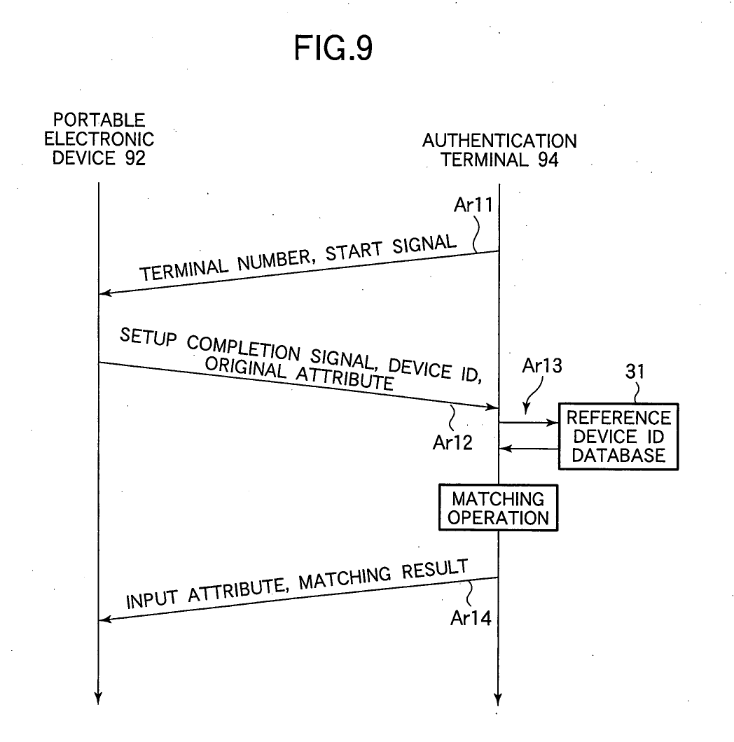

Next, the personal authentication process in the personal authentication system 90 will be described with reference to the flowchart in FIGS. 8A and 8B and the data exchange diagram in FIG. 9. In FIGS. 8A and 8B, the letters P and T and the notations P→T and T→P in parentheses after the step numbers have the same meaning as in FIGS. 5A and 5B.

In step S21 in FIG. 8A, the authenticatee sets the portable electronic device 92 in the authentication terminal 94. This allows the portable electronic device 92 to establish bi-directional communication with the authentication terminal 94, as indicated by the double arrows. The terminal control unit 117 in the authentication terminal 94 then sends a start signal and the terminal number of the authentication terminal 94 to the receiver 32 in the portable electronic device 92 via the terminal transmitter 38 (Aril in FIG. 9). When the control unit 96 in the portable electronic device 92 receives the start signal, it reads the appropriate authentication application program from the control information memory 102. This shifts the portable electronic device 92 into an authentication standby state. The control unit 96 temporarily sores the terminal number of the authentication terminal 94 in the internal memory 99.

Operating according to the application program, the control unit 96 reads the device ID and the original attribute from the attribute memory 24. When the device ID and the original attribute have been read, the transmitter 30 sends the device ID, the original attribute, and a setup completion signal to the terminal receiver 40 in the authentication terminal 94 under control of the control unit 96 (Ar12 in FIG. 9).

In step S22, when the terminal receiver 40 receives the device ID, the original attribute, and the setup completion signal, the terminal CPU 115 temporarily stores the received original attribute in the first memory area 121a in the work memory 121 under control of the terminal control unit 117.

In step S23, the received device ID is temporarily stored in the internal memory 118. Responding to the reception of the device ID, the terminal control unit 117 in the authentication terminal 94 first executes the matching function to verify the device ID. The terminal control unit 117 accesses the database 31 in the host computer via the network, and attempts to read a matching reference device ID. If a matching reference device ID is stored in the database 31, it is sent back to the authentication terminal 94; the terminal control unit 117 verifies that the reference device ID returned from the database 31 matches the device ID stored in the 118 (Ar13 in FIG. 9).

In step S24, when the device ID matches the reference device ID, the terminal control unit 117 concludes that the portable electronic device 92 is an authorized portable electronic device, and a flagging function in the terminal CPU 115 sets an ID matching flag (flg) to ‘1’. This value (flg=1) is stored in the internal memory 118 under control of the terminal control unit 117. If the result of device ID verification is that the device ID stored in the internal memory 118 does not match any reference device ID stored in the database 31, the terminal control unit 117 concludes that the portable electronic device 92 is unauthorized, and the flagging function in the terminal control unit 117 sets the ID matching flag to ‘0’. This value (flg=0) is stored in the internal memory 118 under control of the terminal control unit 117.

In step S25, regardless of whether the value of the ID matching flag is ‘1’ or ‘0’, the terminal control unit 117 accesses the terminal memory unit 113, and requests the authenticatee's attribute. As in the first embodiment, the terminal control unit 117 reads a message from the terminal memory unit 113 and causes the display unit 43 in the authentication terminal 94 to display this message, which asks the authenticatee to enter the attribute. Following the message guidance, the authenticatee inputs his or her attribute, e.g., fingerprint pattern, to the authentication terminal 94 via the attribute reader 34.

In step S26, the terminal control unit 117 temporarily stores the input attribute obtained by the attribute reader 34 in the second memory area 121b in the work memory 121.

In step S27, the terminal CPU 115 in the authentication terminal 94 tests the value of the ID matching flag stored in the internal memory 118 as described above. If the ID matching flag has a value of ‘1’ (flg=1, indicating authorized use) the terminal CPU 115 proceeds to step S28 in FIG. 8B, which will be described later.

If the ID matching flag has a value of ‘0’ (flg=0, indicating unauthorized use) the terminal CPU 115 proceeds to step S36 in FIG. 8B. In step S36, the terminal control unit 117 sends the input attribute of the unauthorized user to the receiver 32 in the portable electronic device 92 via the terminal transmitter 38, together with a signal indicating the negative result of device ID matching (Ar14 in FIG. 9).

In step S37, since the ID matching flag has the value ‘0’, the control unit 96 in the portable electronic device 92 receives the input attribute and stores the received input attribute in the unauthorized attribute memory 28. The terminal CPU 115 then proceeds to step S35.

In step S28, the operation unit 116 executes the attribute matching application program under control of the terminal control unit 117. More specifically, the operation unit 116 performs the matching function that matches the input attribute stored in the second memory area 121b against the original attribute stored in the first memory area 121a.

During matching, under control of the terminal control unit 117, the operation unit 116 reads the feature table 23 of the original attribute stored in the control information memory 119. Referring to the feature table, the operation unit 116 matches the input attribute against the original attribute feature by feature.

In step S29, if the input attribute matches the original attribute, the terminal CPU 115 proceeds to step S30; if the input attribute does not match the original attribute, the terminal CPU 115 proceeds to step S33. The operation unit 116 makes match/non-match decisions on the individual features of the input attribute as in the first embodiment.

If the input attribute matches the original attribute (the matching result is affirmative), the terminal CPU 115 receives a match signal, and the terminal control unit 117 commands the terminal CPU 115 to proceed to steps S30 to S32. If the input attribute does not match the original attribute (the matching result is negative), the terminal CPU 115 receives a non-match signal, and the terminal control unit 117 commands the terminal CPU 115 to proceed to steps S33 to S35.

In step S30, having obtained an affirmative matching result, the terminal transmitter 38 sends a signal indicating this result (match signal) to the receiver 32 in the portable electronic device 92 under control of the terminal control unit 117 (Ar14 in FIG. 9).

In step S31, at the command of the control unit 96 in the portable electronic device 92, the CPU 97 reads the date and time from the real-time clock 13, and the terminal number of the authentication terminal 94 from the internal memory 99. The CPU 97 writes the date, time, and terminal number in the history memory 26.

In step S32, the terminal control unit 117 controls the authentication terminal 94 to permit procedures that may be performed by an authenticated user to proceed. In an ATM system, for example, cash withdrawal is permitted. The personal authentication session ends when the procedure initiated by the authenticatee is completed.

In step S33, the authentication terminal 94 begins the process that is performed when the matching result is negative and the authenticatee is presumed to be a fraudulent user. First, under control of the terminal control unit 117, the terminal transmitter 38 sends the negative matching result (non-match signal) and the input attribute of the fraudulent user to the receiver 32 in the portable electronic device 92 (Ar14 in FIG. 9).

Next, in step S34, when the non-match signal is received, the control unit 96 in the portable electronic device 92 stores the input attribute received from the portable electronic device 92 in the unauthorized attribute memory 28. Accordingly, the unauthorized attribute memory 28 stores the attribute of the fraudulent user.

In step S35, upon receiving the negative matching result (non-match signal), the terminal control unit 117 in the authentication terminal 94 stops the procedure in progress in the authentication terminal 94. The personal authentication process then ends.

Next, the effects of the personal authentication system 90, the portable electronic device 92, and the personal authentication method in the second embodiment will be described.

In the personal authentication system 90, portable electronic device 92, and personal authentication method described above, the original attribute of the authenticatee is stored in the non-rewritable OTP-ROM 44 (attribute memory 24) in the portable electronic device 92. Therefore, tampering with the attribute stored in the portable electronic device 92 is completely prevented, as in the first embodiment.

In the personal authentication system 90, the portable electronic device 92, and the personal authentication method described above, if fraudulent use is attempted, the input attribute of the fraudulent user is stored in the unauthorized attribute memory 28. Accordingly, the attribute of the fraudulent user can be obtained from the portable electronic device 92 and used to identify the fraudulent user, as in the first embodiment.

In the personal authentication system 90, the portable electronic device 92, and the personal authentication method described above, the device ID, the input attribute, and the original attribute are used to determine whether unauthorized use of the portable electronic device 92 is being attempted. The risk of unauthorized use of the portable electronic device 92 can be further reduced, as in the first embodiment, by storing only the device IDs of portable electronic devices 92 that have been issued to authorized users in the database 31 of the host computer. Then even if a fraudulent user steals an unissued portable electronic device 92 not containing any attribute data, and writes the fraudulent user's own attribute into it, use of this unauthorized portable electronic device 92 can be prevented because its device ID will not match any reference device ID stored in the database 31.

In the personal authentication system 90 and the personal authentication method described above, matching is performed in the CPU 115 in the authentication terminal 94. The processing speed of this CPU 115 is generally faster than the processing speed of the CPU 97 used in a portable electronic device 92 such as a smart card. Therefore, the personal authentication system 90 and personal authentication method in the second embodiment can complete the personal authentication procedure in a shorter time than the personal authentication system 10 the personal authentication method in the first embodiment.

A biometric attribute characterizing the authenticatee may be used as an attribute. Examples include fingerprint patterns, voiceprint patterns, iris patterns, and palm vein patterns.

In the second embodiment, an OTP-ROM 44 of the destructive-write type is used as the attribute memory 24. A memory of the nondestructive-write type, however, may be used as the attribute memory 24, provided that data once written cannot be altered or erased.

### Third Embodiment

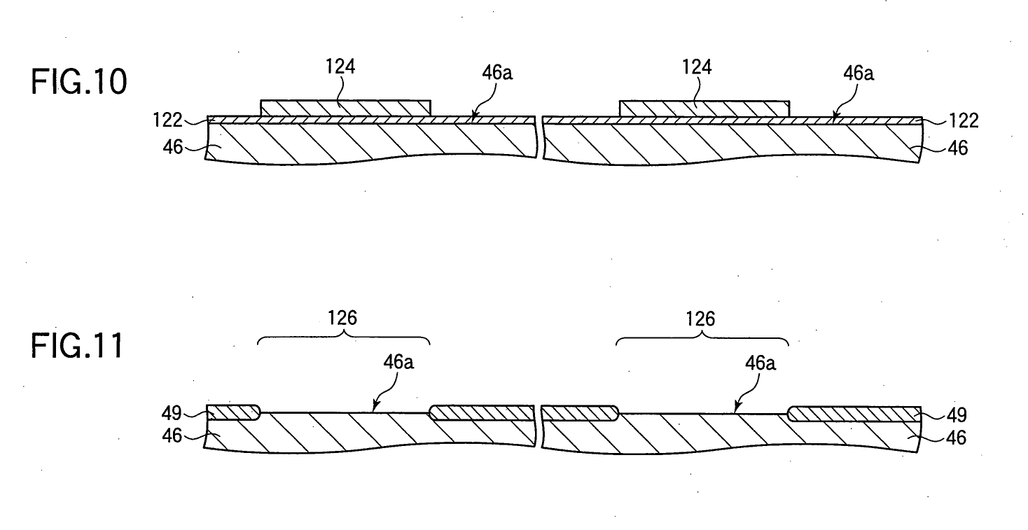

A method of manufacturing a semiconductor device embodying the present invention, for use as the IC chip in the portable electronic device 12 or 92 in the preceding embodiments, will now be described with reference to FIGS. 10 to 17. The semiconductor device comprises an OTP-ROM 44 structured as in FIG. 3A, constituting the attribute memory 24 in FIG. 1, and a nonvolatile RAM 74 structured as in FIG. 4A, constituting the history memory 26 and unauthorized attribute memory 28 in FIG. 1. The following description will focus on the formation of the OTP-ROM 44 and nonvolatile RAM 74; other parts of the semiconductor device may be formed by well-known semiconductor fabrication methods.

A comparison of the OTP-ROM 44 in FIG. 3A with the nonvolatile RAM 74 in FIG. 4A shows that although they differ in the geometry of the capacitors 50 and 76, they both use the same materials and accordingly can be formed simultaneously, as is done in the method described below.

In the first step, shown in FIG. 10, a pad oxide film 122 is formed on the entire first major surface 46a of a substrate 46. A preferred thickness of the pad oxide film 122 is, for example, substantially thirty-five nanometers (35 nm). The pad oxide film 122 is a layer of silicon oxide and is formed by thermal oxidation of the first major surface 46a at a temperature of substantially 850° C.

A silicon nitride film 124 is formed on the pad oxide film 122 by low-pressure chemical vapor deposition (LPCVD) at a temperature of substantially 750° C. A preferred thickness of the silicon nitride film 124 is, for example, substantially 100 nm. The part of the silicon nitride film 124 outside areas in which transistors will be formed is removed by photolithography and etching.

In the second step, shown in FIG. 11, a field oxide layer 49 is formed on the part of the first major surface 46a outside the areas 126 in which transistors will be formed. A preferred thickness of the field oxide layer 49 is, for example, substantially 400 nm. The field oxide layer 49 is formed by steam oxidation at a temperature of substantially 1000° C.

After formation of the field oxide layer 49, the silicon nitride film 124 and the pad oxide film 122 below it are removed by well-known methods, exposing the areas 126 on the first major surface 46a in which transistors will be formed.

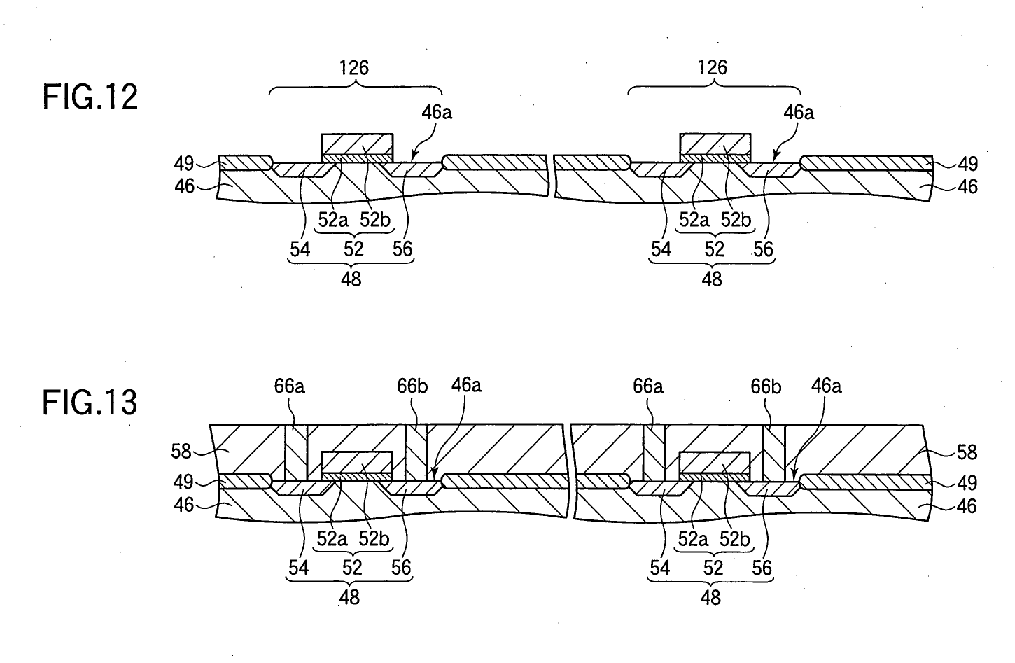

In the third step, shown in FIG. 12, a silicon oxide film is formed on the surfaces of the transistor formation areas 126 as a precursor of a gate oxide film 52a. A preferred thickness of this silicon oxide film is, for example, substantially 10 nm. This silicon oxide film is formed by thermal oxidation at a temperature of substantially 850° C.

A p-doped polysilicon film is then deposited on the entire first major surface 46a of the substrate 46 as a precursor of the gate electrodes 52b of the transistors. A preferred thickness of the polysilicon film is, for example, substantially 200 nm. The p-doped polysilicon film is formed by LPCVD, using a mixture of silane (SiH₄) and phosphine (PH₃) mixed in a suitable ratio as a source gas, at a pressure of substantially 0.1 torr and a temperature of substantially 600° C.

The silicon oxide film and the polysilicon film are then patterned to form transistor gates 52, each comprising a gate oxide film 52a and a gate electrode 52b, by removing the silicon oxide and polysilicon precursor films from the areas outside the gates 52.

Impurity ions are now implanted into the areas in which the drains 54 and sources 56 of the transistors will be formed, using the gates 52 as a mask. Ion implantation is followed by a rapid thermal annealing (RTA) process carried out for substantially thirty seconds at a temperature of substantially 900° C. This process activates the impurities, forming the drains 54 and sources 56 and thereby creating transistors 48.

In the fourth step shown in FIG. 13, a lower dielectric film 58 is formed on the entire first major surface 46a of the substrate 46, covering the transistors 48. A preferred thickness of the lower dielectric film 58 is, for example, substantially 800 nm. The lower dielectric film 58 is a layer of borophosphosilicate glass (BPSG) and is formed by normal-pressure CVD at a temperature of substantially 800° C.

A pair of contact plugs 66a and 66b extending through the lower dielectric film 58 are formed above each transistor. First, the parts of the lower dielectric film 58 through which the contact plugs 66a and 66b extend are removed by photolithography and etching, forming contact holes. Next, a tungsten film substantially 1 μm thick is formed on the entire surface of the lower dielectric film 58 by CVD at a temperature of substantially 300° C., using a tungsten hexafluoride source gas, filling the contact holes with tungsten material. The tungsten film is then etched back to the top surface of the lower dielectric film 58 by a chemical mechanical polishing (CMP) process, leaving the contact plugs 66a and 66b.

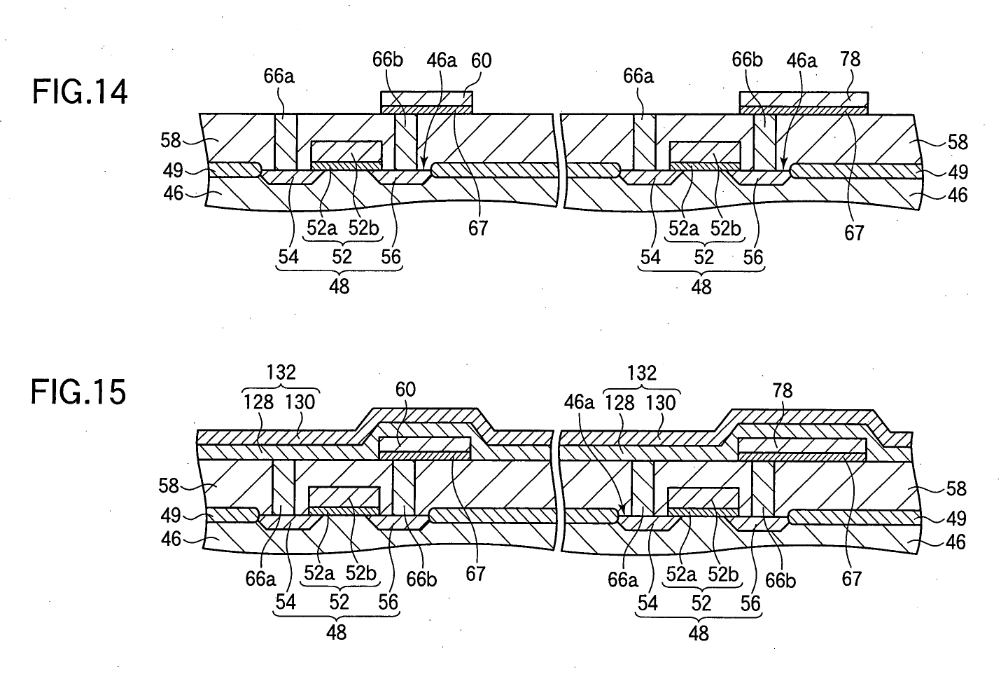

In the fifth step, shown in FIG. 14, a tantalum oxide film is sputtered onto the entire surface of the lower dielectric film 58, including the contact plugs 66a and 66b, as a precursor of an adhesion layer 67. A preferred thickness of the tantalum oxide film is, for example, substantially 50 nm.

A platinum film is then sputtered onto the entire surface of the tantalum oxide film, as a precursor of the lower electrodes 60 and 78 of the memory capacitors. A preferred thickness of the platinum film is, for example, substantially 150 nm.

The tantalum oxide film and the platinum film are patterned by photolithography and etching to form the lower electrodes 60 and 78. More precisely, the platinum film forms the lower electrodes 60 and 78; the tantalum oxide film forms an adhesion layer 67.

In the sixth step, shown in FIG. 15, an SBT film 128 is formed on the entire surface of the lower dielectric film 58, the contact plugs 66a and 66b, and the lower electrodes 60 and 78, covering the lower electrodes 60 and 78. A preferred thickness of the SBT film 128 is, for example, substantially 120 nm. In this step a sol-gel material including the metals strontium, bismuth, and tantalum is applied by spin coating and dried at a temperature of substantially 300° C.; this process is repeated a predetermined number of times to form an SBT precursor film of a preferred thickness. The SBT precursor film is calcined to form a crystallized SBT film 128. A preferred calcining temperature is, for example, substantially 700° C. The SBT film 128 is a precursor of the capacitor dielectric films 62 and 80. The SBT film 128 may also be formed by CVD.

A platinum film 130 is sputtered onto the entire surface of the SBT film 128. A preferred thickness of the platinum film 130 is, for example, substantially 200 nm. The platinum film 130 is a precursor of the upper electrodes 64 and 82. The SBT film 128 and platinum film 130 form a multilayer structure 132.

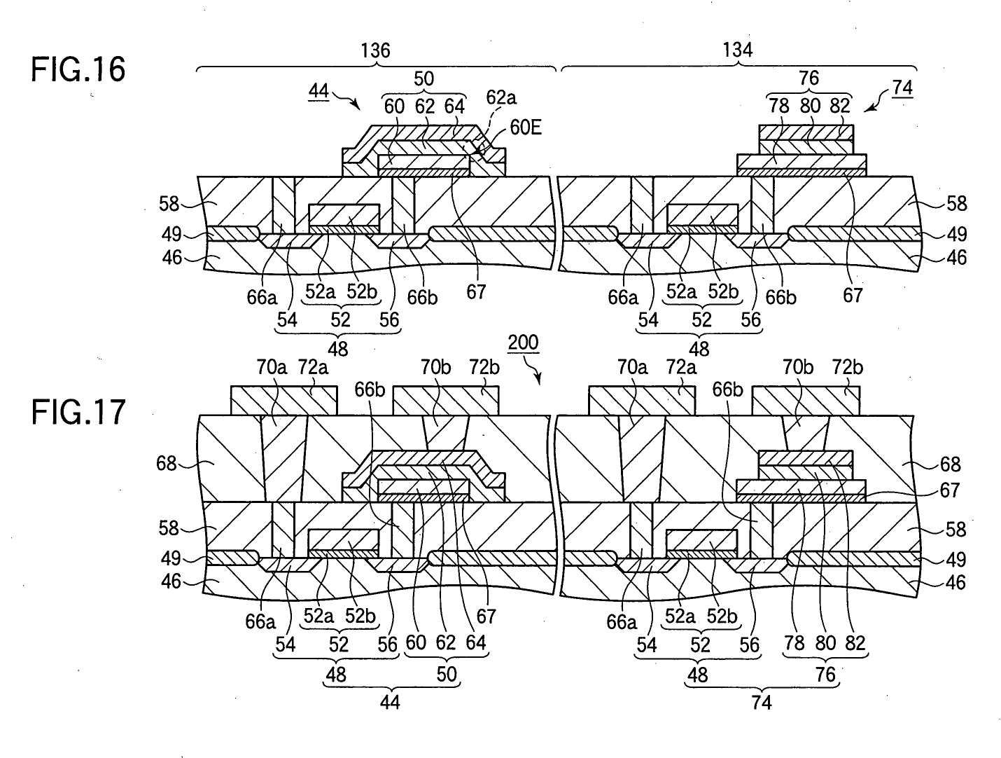

In the seventh step, shown in FIG. 16, the multilayer structure 132 is simultaneously patterned by photolithography and etching in one area 134 to form the nonvolatile RAM 74, and another area 136 to form the OTP-ROM 44.

In the area 134 in which the nonvolatile RAM 74 is formed, the multilayer structure 132 is patterned to leave an island atop each lower electrode 78, occupying an area less than the area occupied by the lower electrode 78. This patterning process creates a nonvolatile RAM 74 in which each memory cell comprises a transistor 48 and a capacitor 76, the capacitor 76 including the lower electrode 78, the capacitor dielectric film 80, and the upper electrode 82.

Simultaneously, in the area 136 in which the OTP-ROM 44 is formed, the multilayer structure 132 is patterned to leave an island occupying an area including the area occupied by each lower electrode 60 but larger than the lower electrode 60. Accordingly, in this area 136 the film thickness of the thin regions 62a where the capacitor dielectric film 62 bends over the upper edges 60E of the lower electrode 60 is less than the film thickness of the flat parts of the capacitor dielectric film 62. This simultaneous patterning process creates an OTP-ROM 44 in which each memory cell comprises a transistor 48 and a capacitor 50, the capacitor 50 including the lower electrode 60, the capacitor dielectric film 62, and the upper electrode 64.

In the eighth step, shown in FIG. 17, an upper dielectric film 68 is formed, contact plugs 70a and 70b are formed above the transistor drains 54 and the upper electrodes 82 of the capacitors in each memory cell, and wires 72a and 72b are formed above the contact plugs 70a and 70b, completing the structure of the memory cells in the semiconductor device. This step is carried out by well-known methods, detailed descriptions of which will be omitted.

The preceding steps form an efficient manufacturing method for a semiconductor device including two types of memories, an OTP-ROM 44 and a nonvolatile RAM 74, that both employ ferroelectric SBT capacitors. This method can be used to manufacture portable electronic devices of the type shown in FIG. 1 or 7 at a reasonable cost.

The preceding embodiments have presented a few examples of systems and methods embodying the present invention, but those skilled in the art will recognize that further variations are possible within the scope of the invention, which is defined in the appended claims.

What is claimed is:

1. A portable electronic device capable of bi-directional communication with an authentication terminal, the portable electronic device including an attribute memory for non-rewritably storing an original attribute characterizing an authenticatee.

2. The portable electronic device of claim 1, wherein the attribute memory is a one-time programmable read-only memory (ROM).

3. The portable electronic device of claim 2, wherein the attribute memory is a ferroelectric one-time programmable ROM.

4. The portable electronic device of claim 1, wherein the original attribute is a biometric attribute of the authenticatee.

5. The portable electronic device of claim 1, further comprising:
a receiver for receiving an input attribute input from the authenticatee via the authentication terminal;
a matching unit for matching the received input attribute against the original attribute read from the attribute memory; and
a transmitter for transmitting a matching result from the matching unit to the authentication terminal.

6. The portable electronic device of claim 5, further comprising a non-volatile random access memory (RAM) for storing the input attribute when the matching result indicates that the input attribute does not match the original attribute.

7. The portable electronic device of claim 6, wherein the non-volatile RAM is a ferroelectric non-volatile RAM.

8. The portable electronic device of claim 7, wherein the attribute memory is a ferroelectric one-time programmable ROM.

9. The portable electronic device of claim 8, wherein:
the ferroelectric non-volatile RAM comprises ferroelectric capacitors, each having a lower electrode, a ferroelectric film, and an upper electrode, the ferroelectric film and the upper electrode having a smaller areal extent than the lower electrode; and
the ferroelectric one-time programmable ROM comprises ferroelectric capacitors, each having a lower electrode, a ferroelectric film, and an upper electrode, the ferroelectric film and the upper electrode having a larger areal extent than the lower electrode.

10. The portable electronic device of claim 1, further comprising a transmitter for reading the original attribute from the attribute memory upon request from the authentication terminal and transmitting the original attribute to the authentication terminal.

11. The portable electronic device of claim 10, further comprising:
a receiver for receiving an input attribute input to the authentication terminal, the input attribute being transmitted from the authentication terminal to the portable electronic device when the input attribute does not match the original attribute; and
a non-volatile RAM for storing the received input attribute.

12. The portable electronic device of claim 11, wherein the non-volatile RAM is a ferroelectric non-volatile RAM.

13. The portable electronic device of claim 12, wherein the attribute memory is a ferroelectric one-time programmable ROM.

14. The portable electronic device of claim 13, wherein:
the ferroelectric non-volatile RAM comprises ferroelectric capacitors, each having a lower electrode, a ferroelectric film, and an upper electrode, the ferroelectric film and the upper electrode having a smaller areal extent than the lower electrode; and
the ferroelectric one-time programmable ROM comprises ferroelectric capacitors, each having a lower electrode, a ferroelectric film, and an upper electrode, the ferroelectric film and the upper electrode having a larger areal extent than the lower electrode.

15. A personal authentication system comprising the portable electronic device of claim 1 and an authentication terminal capable of bi-directional communication with the portable electronic device.

16. The personal authentication system of claim 15, wherein:
the portable electronic device also includes
a first receiver for receiving an input attribute input from the authenticatee via the authentication terminal,
a matching unit for matching the received input attribute against the original attribute stored in the attribute memory, and
a first transmitter for transmitting a matching result from the matching unit to the authentication terminal; and
the authentication terminal includes
an input unit by which the authenticatee inputs the input attribute,
a second transmitter for transmitting the input attribute to the portable electronic device, and
a second receiver for receiving the matching result from the portable electronic device.

17. The personal authentication system of claim 16, wherein the portable electronic device also includes a non-volatile RAM for storing the input attribute received by the first receiver when the input attribute does not match the original attribute.

18. The personal authentication system of claim 15, wherein the portable electronic device also includes a first transmitter for transmitting the original attribute stored in the attribute memory to the authentication terminal, and the authentication terminal includes:
a first receiver for receiving the original attribute from the first transmitter;
an input unit by which the authenticatee inputs the input attribute; and
a matching unit for matching the input attribute against the original attribute received from the portable electronic device.

19. The personal authentication system of claim 18, wherein the authentication terminal also includes a second transmitter for transmitting the input attribute to the portable electronic device when the input attribute does not match the original attribute, and the portable electronic device also includes:
a second receiver for receiving the non-matching input attribute from the second transmitter; and
a non-volatile RAM for storing the non-matching input attribute received by the second receiver.
